(19) United States
(12) Patent Application Publication
(10) Pub. No.: US 2025/0348258 A1
(43) Pub. Date: Nov. 13, 2025

(54) IMAGE FORMING APPARATUS, IMAGE FORMING METHOD, AND RECORDING MEDIUM

(71) Applicant: Hidenori Kinoshita, Tokyo (JP)

(72) Inventor: Hidenori Kinoshita, Tokyo (JP)

(73) Assignee: Ricoh Company, Ltd., Tokyo (JP)

(21) Appl. No.: 19/191,350

(22) Filed: Apr. 28, 2025

(30) Foreign Application Priority Data
May 13, 2024 (JP) 2024-077787
Feb. 25, 2025 (JP) 2025-027774

(51) Int. Cl. G06F 3/12; G03G 15/00

(52) U.S. Cl. CPC G06F 3/1263; G03G 15/6552; G06F 3/1217

(57) ABSTRACT

An image forming apparatus includes: a buffer device to stack a plurality of sheets, each sheet having been printed and to be applied with post-processing based on a first print job, and transmit a stop signal instructing to stop the first print job when the plurality of sheets stacked on the buffer device reaches a predetermined number; a first ejection device to eject the sheet having been printed and applied with the post-processing; a second ejection device to eject the sheet having been printed based on a second print job, the second print job being executed after the first print job is stopped; and circuitry to calculate a predicted printing time of each print job based on printing capability, calculate a predicted post-processing time of each print job based on post-processing capability, and select the second print job based on the predicted printing time and the predicted post-processing time.

### CROSS-REFERENCE TO RELATED APPLICATIONS

This patent application is based on and claims priority pursuant to 35 U.S.C. § 119 (a) to Japanese Patent Application Nos. 2024-077787, filed on May 13, 2024, and 2025-027774, filed on Feb. 25, 2025, in the Japan Patent Office, the entire disclosure of which is hereby incorporated by reference herein.

### BACKGROUND

### Technical Field

The present disclosure relates to an image forming apparatus, an image forming method, and a recording medium.

### Related Art

The background image forming apparatus has a buffer, which is used to compensate for a difference in processing speed between the image forming apparatus and a post-processing apparatus connected to the image forming apparatus. For example, there is a printing apparatus that receives inputs of a plurality of jobs, and performs processing to generate printed sheets. The printing apparatus associates each job with one of a plurality of sheet trays, so that the pages to be output is stored in page queue for each tray.

### SUMMARY

The present disclosure described herein provides an image forming apparatus including: a buffer device to stack a plurality of sheets, each sheet having been printed and to be applied with post-processing based on a first print job, and transmit a stop signal instructing to stop the first print job when the plurality of sheets stacked on the buffer device reaches a predetermined number; a first ejection device to eject the sheet having been printed and applied with the post-processing based on the first print job; a second ejection device to eject the sheet having been printed based on a second print job, the second print job being executed after the first print job is stopped in response to reception of the stop signal; and circuitry to calculate a predicted printing time of each print job based on printing capability of the image forming apparatus, calculate a predicted post-processing time of each print job based on post-processing capability of the image forming apparatus, and select the second print job based on the predicted printing time and the predicted post-processing time.

The present disclosure described herein provides an image forming method, performed by an image forming apparatus. The image forming apparatus includes: a buffer device to stack a plurality of sheets, each sheet having been printed and to be applied with post-processing based on a first print job; a first ejection device to eject the sheet having been printed and applied with the post-processing based on the first print job; and a second ejection device to eject the sheet having been printed based on a second print job. The method includes: transmitting a stop signal instructing to stop the first print job when the plurality of sheets stacked on the buffer device reaches a predetermined number; starting execution of the second print job after the first print job is stopped in response to reception of the stop signal; calculating a predicted printing time of each print job based on printing capability of the image forming apparatus; calculating a predicted post-processing time of each print job based on post-processing capability of the image forming apparatus; and selecting the second print job based on the predicted printing time and the predicted post-processing time.

The present disclosure described herein provides a non-transitory recording medium storing a plurality of instructions which, when executed by one or more processors on an image forming apparatus, perform an image forming method. The image forming apparatus includes: a buffer device to stack a plurality of sheets, each sheet having been printed and to be applied with post-processing based on a first print job; a first ejection device to eject the sheet having been printed and applied with the post-processing based on the first print job; and a second ejection device to eject the sheet having been printed based on a second print job. The method includes: transmitting a stop signal instructing to stop the first print job when the plurality of sheets stacked on the buffer device reaches a predetermined number; starting execution of the second print job after the first print job is stopped in response to reception of the stop signal; calculating a predicted printing time of each print job based on printing capability of the image forming apparatus; calculating a predicted post-processing time of each print job based on post-processing capability of the image forming apparatus; and selecting the second print job based on the predicted printing time and the predicted post-processing time.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an example configuration of an image forming apparatus;

FIG. 2 is a block diagram illustrating a hardware configuration of the image forming apparatus;

FIG. 3 is a diagram of example functional blocks of the image forming apparatus;

FIG. 4 is a diagram illustrating an example of a sheet having job information printed thereon, which is ejected by the image forming apparatus;

FIGS. 5A and 5B are a flowchart of an image forming method executed by the image forming apparatus;

FIG. 6 is a diagram illustrating the relationship between the progress, the post-processing speed, and the printing speed, for each print job in the image forming apparatus;

FIGS. 7A and 7B (FIG. 7) are diagrams illustrating first example processing of the image forming apparatus;

FIGS. 8A, 8B, and 8C (FIG. 8) are diagrams illustrating second example processing of the image forming apparatus; and

FIGS. 9A, 9B, and 9C (FIG. 9) are diagrams illustrating third example processing of the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Structure of Image Forming Apparatus

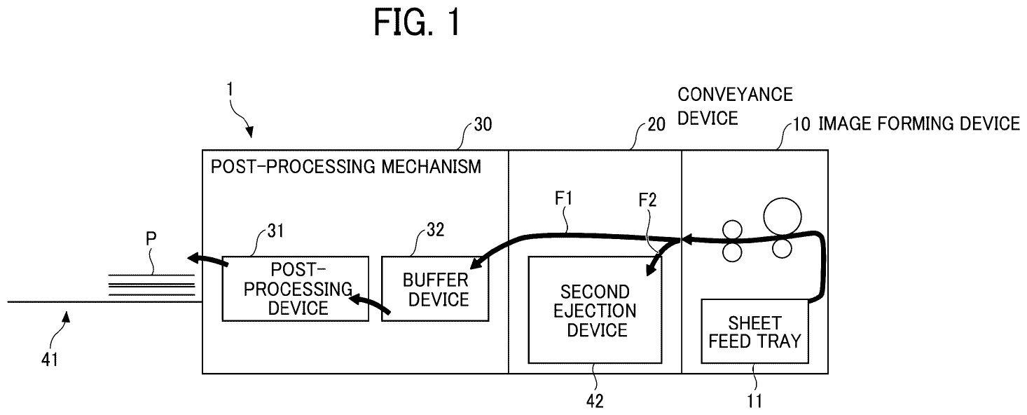

FIG. 1 is a schematic diagram of an overall configuration of an image forming apparatus 1. The image forming apparatus 1 may be, for example, a multifunction peripheral (MFP) including functions of a printer, a copier, and a facsimile, or an electronic device including an image forming function such as a printer.

The image forming apparatus 1 includes an image forming device 10, a conveyance device 20 including a second ejection device 42, and a post-processing mechanism 30 including a first ejection device 41. Arrows in the drawing indicate the passage of a sheet P that the image forming device 10 outputs as a printed sheet P. In this example, a first print job is a print job, in which the printed sheet P is applied with post-processing and is ejected to the first ejection device 41. A second print job is a print job, in which the printed sheet P is ejected to the second ejection device 42. The arrow F1 in the drawing indicates a passage of the printed sheet P printed by the first print job. The arrow F2 in the drawing indicates a passage of the printed sheet P printed by the second print job. The first ejection device 41 and the second ejection device 42 may each be implemented by a tray or a table.

The image forming device 10 includes a sheet feed tray 11. The image forming device 10 performs printing for each print job to form an image on the sheet P, which is supplied from the sheet feed tray 11. The printed sheet P is conveyed in the direction of the arrow in the drawing. Examples of the sheet P include, but not limited to, printing paper.

The conveyance device 20 conveys the printed sheet P printed by the first print job to the post-processing mechanism 30. The post-processing mechanism 30 includes a post-processing device 31 and a buffer device 32. The post-processing mechanism 30 is located downstream of the image forming device 10 and performs post-processing on the printed sheet P.

Examples of the post-processing performed by the post-processing device 31 include, but not limited to, alignment processing for aligning the sides of the printed sheets P, folding processing for folding the printed sheets P, binding processing for binding a bundle of the printed sheets P whose sides are aligned, saddle stitching processing for folding the printed sheets P in two and binding the printed sheets P. The printed sheet P ejected to the second ejection device 42 may be manually moved to the post-processing mechanism 30 and applied with post-processing.

The buffer device 32 stacks the printed sheets P, each printed by the first print job, before the post-processing is performed on the printed sheet P. This prevents the printed sheet P from staying on the discharge path due to the difference between the speed of the post-processing performed by the post-processing device 31 and the speed of the printing performed by the image forming device 10.

The buffer device 32 transmits a stop signal to the image forming device 10, which instructs to stop the first print job when the printed sheets P are fully loaded. The image forming device 10 stops the first print job in response to reception of the stop signal. When the first print job is stopped, the image forming device 10 starts printing based on the second print job is started, if the second print job is to be performed.

The first ejection device 41 ejects the printed sheet P, on which printing has been performed and post-processing has been performed based on the first print job. The second ejection device 42 ejects the printed sheet P, which is printed based on the second print job. As described above, the second print job has executed after the first print job is stopped in response to reception of the stop signal.

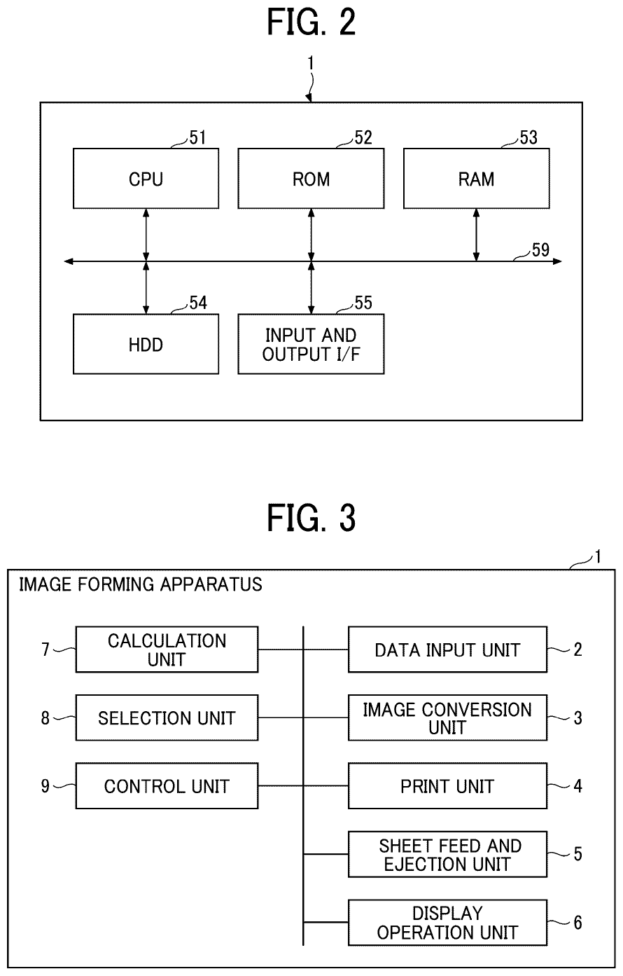

FIG. 2 is a diagram illustrating an example hardware configuration of a control section of the image forming apparatus 1. The control section of the image forming apparatus 1 includes a central processing unit (CPU) 51, a read only memory (ROM) 52, a random access memory (RAM) 53, a hard disk drive (HDD) 54, and an input and output interface (I/F) 55. These elements are electrically connected to each other via a bus 59.

The CPU 51 controls the operation of the image forming apparatus 1. The ROM 52 stores a program executed by the CPU 51. The RAM 53 is used as a work area for the CPU 51. The HDD 54 stores various kinds of information such as programs. The input and output I/F 55 is an interface circuit, which inputs or outputs various signals and data to and from an external device.

A part or all of the functions of the CPU 51 may be implemented by an electronic circuit such as an application specific integrated circuit (ASIC) or a field-programmable gate array (FPGA).

By providing the buffer device 32, even if there is a difference between the speed of the post-processing by the post-processing device 31 and the printing speed of the image forming device 10, printing based on the print job can be intermittently performed. When the buffer device 32 transmits the stop signal, the image forming device 10 that has received the stop signal temporarily stops printing. This decreases the printing efficiency.

While the capacity of the buffer device 32 can be increased, the printed sheets P may be fully loaded, and printing may be temporarily stopped. Further, when the printed sheets P are fully loaded in the buffer device 32, the printed sheets P are ejected to the second ejection device 42 for the print job being executed. Accordingly, the printed sheets P printed for one print job will be ejected to different places. It may take time and effort to gather the printed sheets P, ejected to different places.

Further, if printing of another print job is started while printing of the print job being executed is temporarily stopped in response to the stop signal, the printed sheets P may be ejected in the order different from the order of receiving the print jobs each causing printing of the corresponding printed sheet P. Further, it may be preferable to execute a job that uses the post-processing device 31, such that a time during which the post-processing device 31 does not operate is reduced.

In view of the above, the image forming apparatus 1 has example functional blocks as follows.

FIG. 3 is a diagram of example functional blocks of the image forming apparatus 1. The image forming apparatus 1 includes a data input unit 2, an image conversion unit 3, a print unit 4, a sheet feed and ejection unit 5, a display operation unit 6, a calculation unit 7, a selection unit 8, and a control unit 9.

The data input unit 2 receives an input of a print job. The data input unit 2 is implemented by the input and output I/F 55, which may receive the print job from the external device such as a personal computer.

The image conversion unit 3 performs processing, such as processing to convert a format of image data into a format that can be processed in a subsequent stage. Specifically, the image conversion unit 3 converts the image data into pixel data of black, magenta, cyan, and yellow. The image conversion unit 3 is implemented by the CPU 51.

The print unit 4 prints an image on the sheet P based on the print job. The print unit 4 is implemented by the image forming device 10.

The sheet feed and ejection unit 5 feeds the sheet P from the sheet feed tray 11 to a conveyance passage. The sheet feed and ejection unit 5 further conveys the printed sheet P to the first ejection device 41 or the second ejection device 42. The sheet feed and ejection unit 5 may be implemented by rollers or belts of the image forming device 10 and the post-processing mechanism, which operate under control of the CPU 51.

The display operation unit 6 is, for example, an operation panel having a display, and displays an operation on the image forming apparatus 1, a state of the apparatus, or the operation progress.

The calculation unit 7 calculates a predicted printing time for each print job, which is the time it takes for printing, based on the printing capability of the image forming apparatus 1. The calculation unit 7 calculates a predicted post-processing time for each print job, which is the time it takes for post-processing, based on the post-processing capability of the image forming apparatus 1.

The calculation unit 7 calculates a print suspension time, which is the time during which the first print job is suspended by the stop signal. The print suspension time is a time obtained by subtracting the predicted printing time from the predicted post-processing time. The calculation unit 7 further calculates a cumulative print suspension time, which is the cumulative value of the print suspension times for the plurality of first print jobs. The calculation unit 7 is implemented by the CPU 51.

As described above, the calculation unit 7 calculates the processing time for each print job, which includes the predicted printing time, the predicted post-processing time, the print suspension time, and the cumulative print suspension time.

The selection unit 8 selects, from the plurality of print jobs, a print job to be the second print job based on the predicted printing time and the predicted post-processing time. More specifically, the selection unit 8 selects the print job to be the second print job based on a comparison between the predicted printing time and the cumulative print suspension time.

More specifically, the selection unit 8 assumes that the predicted printing time of the first print job is equal to or longer than the cumulative print suspension time of the first print job, which is received immediately before the first print job. If the predicted printing time of the first print job is less than the cumulative print suspension time of the first print job, which is received immediately after the first print job, excluding the print suspension time of the first print job, the first print job is selected as the second print job.

By selecting the second job in this way, the selection unit 8 can prioritize printing by the first print job that performs post-processing, and can complete printing in the order of receiving the print jobs. The selection unit 8 is implemented by the CPU 51.

The control unit 9 controls the entire operation of the image forming apparatus 1. The control unit 9 causes the image forming device 10 to perform printing based on the first print job. The control unit 9 determines a conveyance passage through which the printed sheet P, which is printed by any one of the first print job and the second print job, is conveyed. The control unit 9 is implemented by the CPU 51.

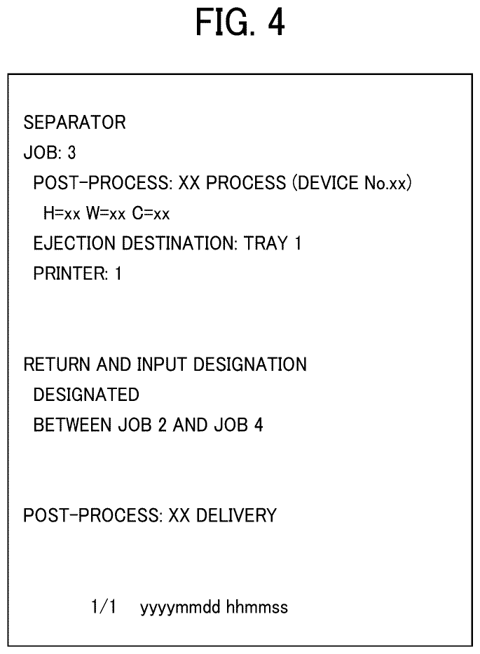

FIG. 4 is a diagram illustrating an example of a sheet having job information printed thereon, which is ejected by the image forming apparatus 1. The image forming apparatus 1 may eject the printed sheet P on which the job information indicating the sequence between the first print job and the second print job is printed, after printing by the print jobs is completed.

In the illustrated example, the print jobs are received in the order of job 1, job 2, job 3, and job 4. The job 1, the job 2, and the job 4 are the first print job, and the job 3 is the second print job. The printed sheets P printed by the job 1, the job 2, and the job 4 are ejected from the first ejection device 41, and the printed sheets P printed by the job 3 are ejected from the second ejection device 42.

The illustrated sheet P indicates that the printed sheet P printed by the job 3 is to be inserted between the printed sheet P printed by the job 2 and the printed sheet P printed by the job 4. The printed sheets P ejected from the first ejection device 41 and the second ejection device 42 are in the order of receiving the corresponding print jobs, such that the user can easily perform operation on the ejected sheets P as needed.

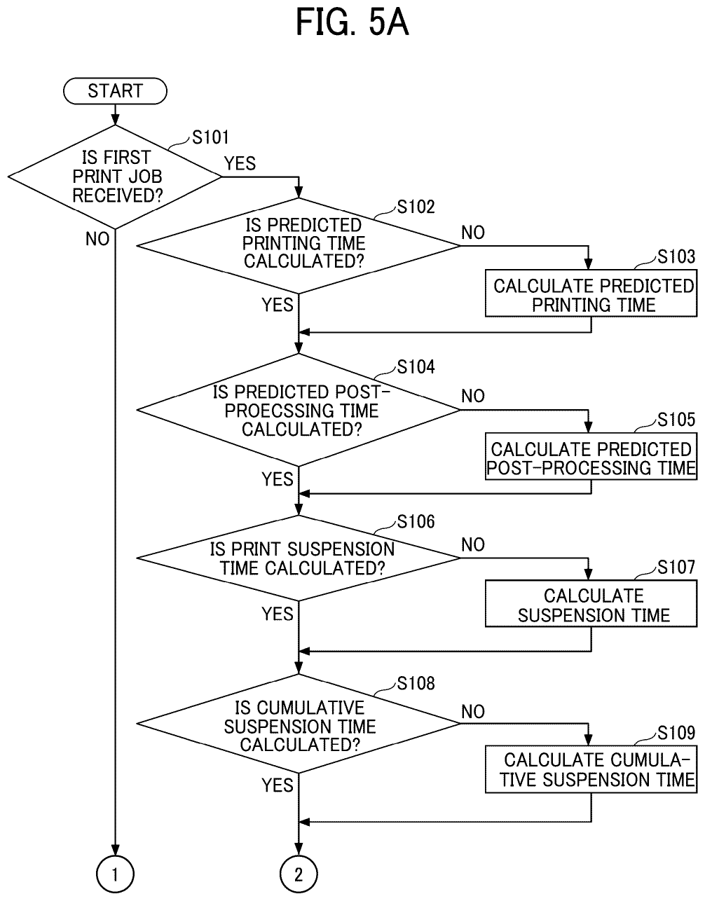

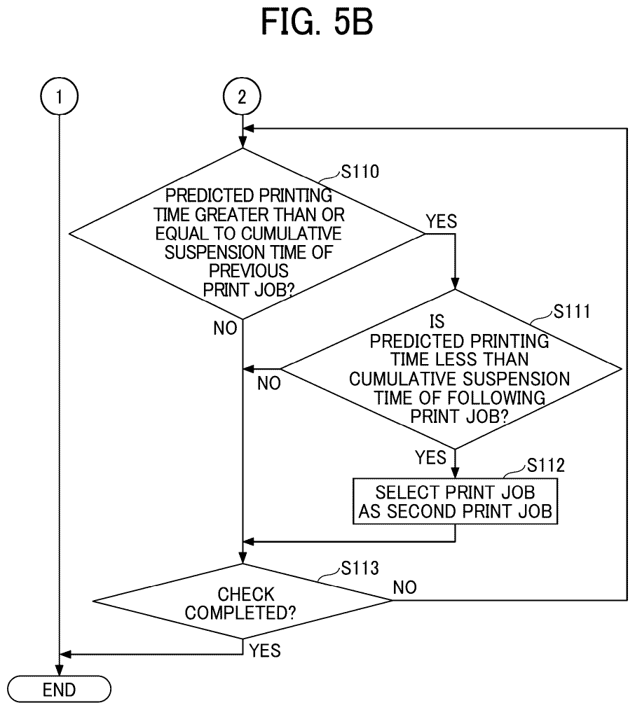

FIGS. 5A and 5B are a flowchart of an image forming method executed by the CPU 51 of the image forming apparatus 1.

At S101, it is determined whether the first print job has been received. It is assumed that any print job being received is first determined as the first print job. When the first print job is received (Yes at S101), at S102, it is determined whether there is a print job for which the predicted printing time is not calculated. If there is a print job for which the predicted printing time is not calculated (No at S102), at S103, the calculation unit 7 calculates the predicted printing time based on the printing capability of the image forming apparatus 1.

When the predicted printing time is calculated (Yes at S102), at S104, it is determined whether there is a print job for which the predicted post-processing time is not calculated. When there is a print job for which the predicted post-processing time is not calculated (No at S104), at S105, the calculation unit 7 calculates the predicted post-processing time based on the post-processing capability of the image forming apparatus 1.

When the predicted post-processing time is calculated (Yes at S104), at S106, the calculation unit 7 determines whether there is a print job for which the print suspension time is not calculated. When there is a print job for which the print suspension time is not calculated (No at S106), at S107, the calculation unit 7 calculates the print suspension time, which is a time obtained by subtracting the predicted printing time from the predicted post-processing time.

When the print suspension time is calculated (Yes at S106), at S108, the calculation unit 7 determines whether there is a print job for which the cumulative print suspension time is not calculated. When there is a print job for which the cumulative print suspension time is not calculated (No at S108), at S109, the calculation unit 7 calculates the cumulative print suspension time, which is the cumulative value of the print suspension times of the plurality of first print jobs.

When the cumulative print suspension time is calculated (Yes at S108), at S110 and S111, the calculation unit 7 checks the first print jobs, which are the received print jobs, in the order of receiving the print jobs. When the predicted printing time of the first print job is equal to or greater than the cumulative print suspension time of the first print job received immediately before the first print job (Yes at S110), the operation proceeds to S111. When the predicted printing time of the first print job is less than the print suspension time obtained by subtracting the print suspension time of the first print job from the cumulative print suspension time of the first print job received immediately after the first print job (Yes at S111), at S112, the selection unit 8 selects the first print job as the second print job. On the other hand, when the predicted printing time of the first print job is less than the cumulative print suspension time of the first print job received immediately before the first print job (No at S110), the first print job is not selected as the second print job. Similarly, when the predicted printing time of the first print job is equal to or greater than the print suspension time obtained by subtracting the print suspension time of the first print job from the cumulative print suspension time of the first print job received immediately after the first print job (No at S111), the first print job is not selected as the second print job.

At S113, it is determined whether the processing is completed for all print jobs. When it is confirmed that the processing is completed (Yes at S113), the operation ends.

Through the operation of FIGS. 5A and 5B, the plurality of print jobs being received are classified into the first print job and the second print job.

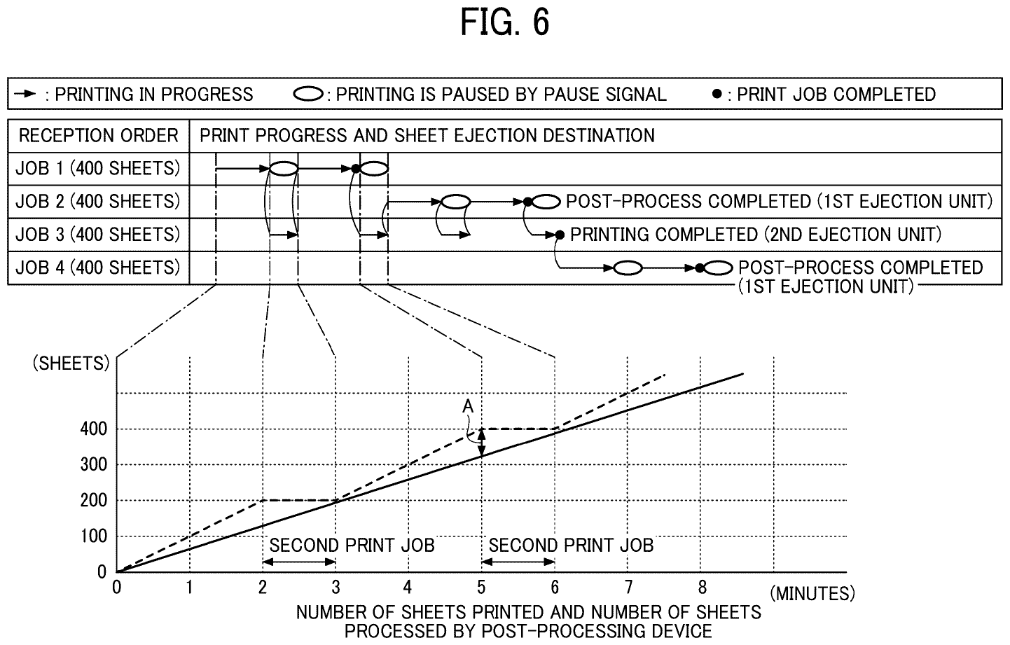

FIG. 6 is a diagram illustrating the relationship between the progress, the post-processing speed, and the printing speed, for each print job in the image forming apparatus 1. The solid line of the graph indicates the number of printed sheets P on which the post-processing has been performed. The broken line in the graph indicates the number of printed sheets P on which the printing has been performed. The arrow A indicates the number of printed sheets P stacked on the buffer device 32.

In the example of FIG. 6, at the image forming apparatus 1, the print jobs are received in the order of job 1, job 2, job 3, and job 4. The job 1, job 2, and job 4 are the first print jobs, and job 3 is the second print job. It is assumed that each print job instructs to print 400 sheets. Further, it is assumed that the post-processing speed is 66 sheets per minute, and the printing speed is 100 sheets per minute. The buffer device 32 can hold 68 sheets at the maximum.

At one minute after the start of printing based on the job 1, 100 sheets are printed and 66 sheets are processed by the post-processing. The buffer device 32 has 34 sheets P. At two minutes after the start of printing based on the job 1, 200 sheets are printed, and 132 sheets are processed by the post-processing. The buffer device 32 has 68 sheets P.

In other words, at two minutes after the start of printing based on the job 1, the buffer device 32 is fully loaded with the sheets P. The buffer device 32 transmits a stop signal instructing to stop the printing by the job 1, and the printing based on the job 1 is temporarily stopped. Then, the printing by the job 3 is started, and the printed sheets P are ejected to the second ejection device 42.

At three minutes after the start of printing based on the job 1, 198 sheets are processed by the post-processing, and two sheets P are stacked in the buffer device 32. Since the buffer device 32 is not fully loaded with the sheets P, suspension of the printing based on the job 1 is canceled, and the printing based on the job 1 is resumed. The image forming apparatus 1 continues the above-described processing. After the stop signal instructing to stop the printing is transmitted, the printing of the print job for which the printing is stopped is not started until the number of stacked sheets in the buffer device 32 becomes equal to or less than the predetermined number of sheets. In the above-described example, the suspension of the printing of the job 1 is not canceled until the number of remaining sheets P becomes two, which is obtained by subtracting the number of sheets that can be post-processed in one minute (in this case, 66) from the number of sheets that the buffer device 32 can hold (in this case, 68).

In the case of the above-described printing speed and post-processing speed, the number of sheets P on the buffer device 32 after 5 minutes from the start of printing is 70 sheets in calculation. In other words, the buffer device 32 becomes full again shortly before 5 minutes passes from the start of printing. In order to prevent such a situation, when the remaining number of sheets to be printed in the job is relatively small, for example, five sheets or less, and the buffer device 32 is full, the printing may be temporarily stopped, while executing only the post-processing for a certain period of time. Through this processing, even when the remaining number of sheets P to be printed is printed, the buffer device 32 can be prevented from being full.

In the example illustrated in FIG. 6, after 2 to 3 minutes and 5 to 6 minutes from the start of printing, the printing by the job 1, which is the first print job, is stopped, and the printing by the job 3, which is the second print job, is started. Further, after 6 minutes from the start of printing, the printing of the job 2 is started. After 8 to 9 minutes and 11 to 12 minutes from the start of printing, the printing by the job 2, which is the first print job, is stopped, and the printing by the job 3, which is the second print job, is started. After the printing of the job 1 and the printing of the job 2 are completed, the printing of the job 3 is completed, and then the printing of the job 4 is completed. Therefore, the print jobs are completed in the order of the job 1, the job 2, the job 3, and the job 4, which is the order of reception of the print jobs at the image forming apparatus 1.

### First Example

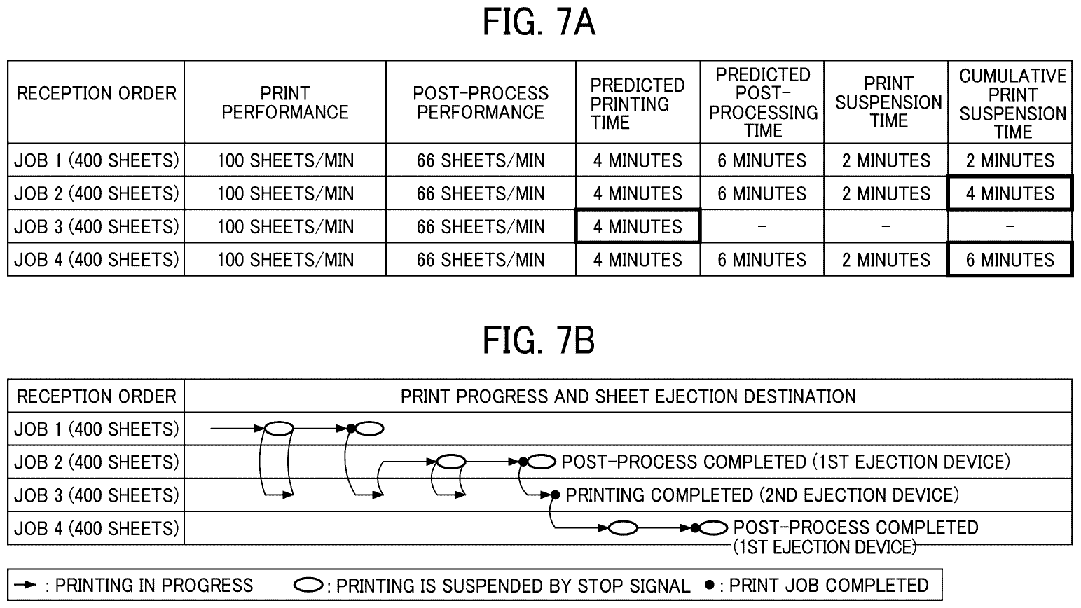

FIGS. 7A and 7B (FIG. 7) are diagrams illustrating first example processing of the image forming apparatus 1. FIG. 7A is a table illustrating job information of each print job. FIG. 7B is a diagram illustrating the progress of each print job.

In the illustrated example, the print jobs are received in the order of job 1, job 2, job 3, and job 4. It is assumed that each print job instructs to print 400 sheets. Further, it is assumed that the printing speed is 100 sheets per minute, and the post-processing speed is 66 sheets per minute. The buffer device 32 can hold 68 sheets at the maximum. The time until the buffer device 32 is fully loaded with the sheets P is calculated by 68/(100-66), and is about 2 minutes.

Referring back to FIG. 5A, the image forming apparatus 1 receives the job as a first print job (Yes at S101). It is assumed that all values are calculated (Yes at S102 to S108). When the predicted printing time of the first print job is equal to or longer than the cumulative print suspension time of the first print job received immediately before the first print job (Yes at S110), and the predicted printing time of the first print job is less than the cumulative print suspension time of the first print job received immediately after the first print job excluding the print suspension time of the first print job (Yes at S111), the first print job is selected as the second print job (S112).

In the illustrated example, the predicted printing time of the job 2 is 4 minutes, which is equal to or longer than 2 minutes that is the cumulative print suspension time of the job 1 (Yes at S110 in FIG. 5A), and thus, the job 2 is a candidate of the second print job. Since the job 2 is a candidate of the second print job, the operation proceeds to S111. The cumulative print suspension time of the next job 3 is 4 minutes, which is obtained by subtracting the print suspension time (2 minutes) of the job 2 from the cumulative print suspension time (6 minutes) of the next job 3. The predicted printing time of the job 2, which is 4 minutes, is not less than the cumulative printing suspension time of the job 3 (No at S111 in FIG. 5B), which is also 4 minutes. Thus, the job 2 is not selected as the second print job (No at S111).

The predicted printing time of the job 3 is 4 minutes, which is longer than the cumulative print suspension time of the job 2, which is 4 minutes (Yes at S110). Therefore, the job 3 is a candidate of the second print job, and the operation proceeds to S111. The cumulative print suspension time of the next job 4 is 6 minutes, which is obtained by subtracting the print suspension time (0 minute) of the job 3 from the cumulative print suspension time (6 minutes) of the next job 4. The predicted printing time of the job 3, which is 4 minutes, is less than the cumulative print suspension time of the job 4, which is 6 minutes (Yes at S111).

A print job having the predicted printing time, which is equal to or longer than the cumulative print suspension time of the job received immediately before the print job, and is less than the cumulative print suspension time of the job received immediately after the print job, is the job 3. In other words, the selection unit 8 selects the job 3 as the second print job.

As illustrated in FIG. 7B, while the printing by the job 1 and the job 2 which are the first print job is temporarily stopped, the printing by the job 3, which is the second print job, is started. Therefore, the print jobs are completed in the order of the job 1, the job 2, the job 3, and the job 4, which is the order of reception, without cancelling any of the job 1 to the job 4.

### Second Example

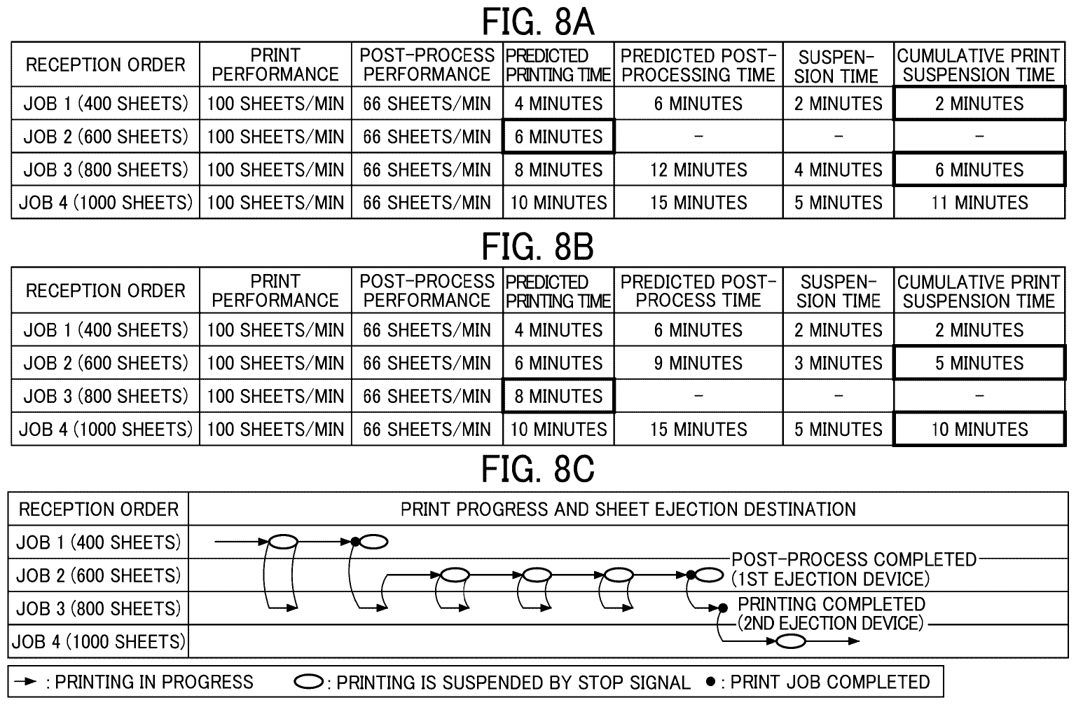

FIGS. 8A, 8B, and 8C (FIG. 8) are diagrams illustrating second example processing of the image forming apparatus 1. FIGS. 8A and 8B are tables each illustrating job information of each print job. FIG. 8C is a diagram illustrating the progress of each print job.

In the illustrated example, at the image forming apparatus 1, the print jobs are received in the order of job 1, job 2, job 3, and job 4. It is assumed that the job 1, the job 2, the job 3, and the job 4 instruct to print 400 sheets, 600 sheets, 800 sheets, and 1000 sheets, respectively. Further, it is assumed that the printing speed is 100 sheets per minute, and the post-processing speed is 66 sheets per minute. The buffer device 32 can hold 68 sheets at the maximum. The time until the buffer device 32 is fully loaded with the sheets P is about 2 minutes as in the first example.

Referring to FIG. 5A, it is assumed that all values are calculated (Yes at S102 to S108). Then, it is determined whether the job 2 is selected as the second print job. In the example illustrated in FIG. 8A, the predicted printing time of the job 2 is 6 minutes, which is longer than the cumulative print suspension time of the job 1, which is 2 minutes (Yes at S110). The predicted printing time of the job 2, which is 6 minutes, is not less than the cumulative print suspension time of the job 3 excluding the print suspension time of the job 2, which is 6 minutes (No at S111). The job 2 is not selected as the second print job.

Next, it is determined whether the job 3 is selected as the second print job. In the example illustrated in FIG. 8B, the predicted printing time of the job 3 is 8 minutes, which is equal to or longer than the cumulative print suspension time of the job 2, which is 5 minutes (Yes at S110). The predicted printing time of the job 3, which is 8 minutes, is less than the cumulative print suspension time of the job 4 excluding the print suspension time of the job 3, which is 10 minutes (Yes at S111).

A print job having the predicted printing time, which is equal to or longer than the cumulative print suspension time of the job received immediately before the print job, and is less than the cumulative print suspension time of the job received immediately after the print job, is the job 3. In other words, the selection unit 8 selects the job 3 as the second print job.

As illustrated in FIG. 8C, while the printing by the job 1, the job 2, and the job 4, which are the first print job, is temporarily stopped, the printing by the job 3, which is the second print job, is started. Therefore, the print jobs are completed in the order of the job 1, the job 2, the job 3, and the job 4, which is the order of reception, without cancelling any of the job 1 to the job 4.

In the illustrated example, printing of the first to 100th sheets of the job 3 is executed during the suspension of printing after printing the first to 200th sheets of the job 1. Subsequently, printing of the 201st to 400th sheets of the job 1 is completed, and the processing of the job 1 ends.

During the suspension of printing after the end of job 1, printing of the job 3 from the 101st sheet to the 200th sheet is executed, and printing of the job 2 from the first sheet to the 200th sheet is executed. While printing of the job 2 is temporarily stopped, printing of the 201st sheet to the 300th sheet of the job 3 is executed. Thereafter, printing of the 201st sheet to the 400th sheet of the job 2 is executed. While printing of the job 2 is temporarily stopped, printing of the 301st sheet to the 400th sheet of the job 3 is executed. Subsequently, printing of the 401st sheet to the 600th sheet of the job 2 is completed, and the processing of the job 2 ends.

During the suspension of printing after the end of the job 2, printing of the 401st sheet to the 500th sheet of the job 3 is executed. Subsequently, printing of the first to 200th sheets of the job 4 is executed. During the time when printing is temporarily stopped for the job 4, printing of the 501st sheet to the 600th sheet of the job 3 is executed. Subsequently, printing of the 201st sheet to the 400th sheet of the job 4 is executed. During the time when printing is temporarily stopped for the job 4, printing of the 601st sheet to the 700th sheet of the job 3 is executed. Subsequently, printing of the 401st sheet to the 600th sheet of the job 4 is executed. During the time when printing is temporarily stopped for the job 4, printing of the 701st sheet to the 800th sheet of the job 3 is executed.

The job 4 is executed until printing of the job 4 is completed.

### Third Example

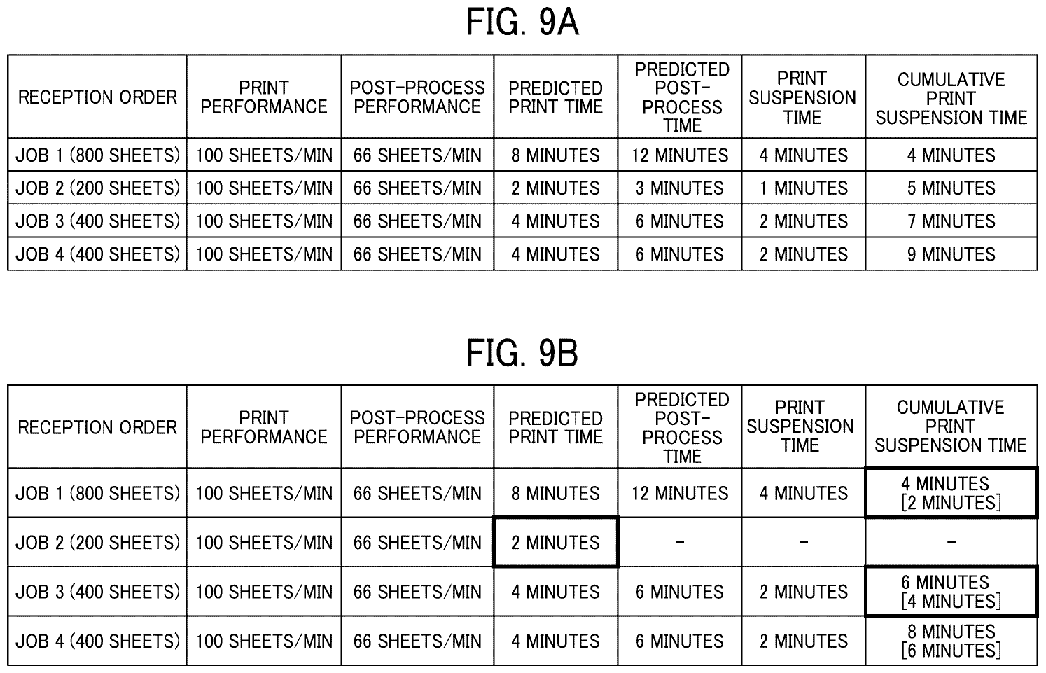

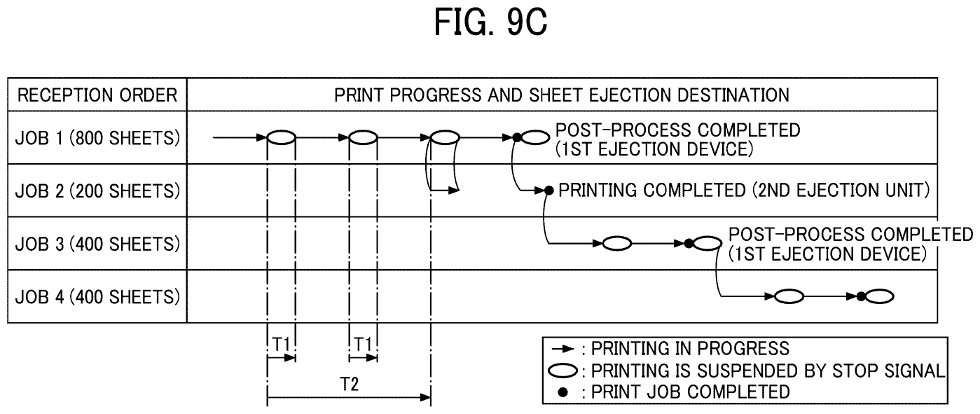

FIGS. 9A, 9B, and 9C (FIG. 9) are diagrams illustrating third example processing of the image forming apparatus 1. FIGS. 9A and 9B are tables each illustrating job information of each print job. FIG. 9C is a diagram illustrating the progress of each print job.

In the illustrated example, at the image forming apparatus 1, the print jobs are received in the order of job 1, job 2, job 3, and job 4. It is assumed that the job 1, the job 2, the job 3, and the job 4 instruct to print 800 sheets, 200 sheets, 400 sheets, and 400 sheets, respectively. Further, it is assumed that the printing speed is 100 sheets per minute, and the post-processing speed is 66 sheets per minute. The buffer device 32 can hold 68 sheets at the maximum. The time until the buffer device 32 is fully loaded with the sheets P is about 2 minutes as in the first example.

Referring back to FIG. 5A, in the example illustrated in FIG. 9, the predicted printing time of the job 2 is 2 minutes, which is not longer than the cumulative print suspension time of the job 1, which is 4 minutes (No at S110). The predicted printing time of the job 3 is 4 minutes, which is not longer than the cumulative print suspension time of the job 2, which is 5 minutes (No at S110). The predicted printing time of the job 4 is 4 minutes, which is not longer than the cumulative print suspension time of the job 3, which is 7 minutes (No at S110). In other words, none of the print jobs are selected as the second print job.

In this example, the CPU 51 of the image forming apparatus 1 determines whether the print job can be executed by delaying the timing of printing by the second print job that ejects the sheet to the second ejection device 42. More specifically, the control unit 9, which is implemented by the CPU 51, delays the timing of starting printing, such that the cumulative print suspension time of the first print job is equal to or less than the predicted printing time of the first print job received immediately after the first print job.

In the example illustrated in FIG. 9B, it is assumed that all values are calculated (Yes at S102 to S108). Then, it is determined whether the job 2 is selected as the second print job. The cumulative print suspension time of the job 1 is 4 minutes, and the predicted print time of the job 2 is 2 minutes. If the job 2 is to be set as the second print job, based on the predicted printing time, the control unit 9 delays the timing of starting the printing of the job 2 until the cumulative print suspension time becomes 2 minutes (4 minutes-2 minutes). In the “cumulative print suspension time” field of FIG. 9B, the time value in parentheses is the time for each print job, when the timing of starting printing is delayed by two minutes.

T1 in FIG. 9C indicates a time period for each time the printing is suspended during the execution of the job 1. T2 indicates a time period for delaying the start of printing of the job 2. Referring to FIG. 9B, the print suspension time of the job 1 is 4 minutes. The number of times the printing is suspended during execution of the job 1 is four. Therefore, T1 is 1 minute.

The timing of starting printing by the job 2 is delayed by 2 minutes. In other words, printing based on the job 2 is not started for two times of the printing suspension in the job 1. As indicated by T2 of FIG. 9C, the timing at which printing of the job 2 is started is equal to the timing at which printing of the job 1 is temporarily stopped at the third time.

At this time, the predicted printing time of the job 2 is 2 minutes, which is longer than 2 minutes, which is the cumulative print suspension time obtained by delaying the timing of starting the printing of the job 1. The predicted printing time of the job 2, which is 2 minutes, is less than the cumulative print suspension time of 4 minutes, which is the cumulative print suspension time excluding the print suspension time of the job 2, which is obtained by delaying the timing of starting printing of the job 3. In other words, the selection unit 8 selects the job 3 as the second print job.

As illustrated in FIG. 9C, while the printing by the job 1 as the first print job is temporarily stopped, the printing by the job 2 as the second print job is executed. Therefore, the print jobs are completed in the order of the job 1, the job 2, the job 3, and the job 4, which is the order of reception, without cancelling any of the job 1 to the job 4.

As described above, the image forming apparatus 1 starts printing based on the second print job during a waiting time for the first print job. The predicted printing time of the second print job is equal to or longer than the cumulative print suspension time of the print job received immediately before the second print job, and less than the cumulative print suspension time of the print job received immediately after the second print job. The second print job is a print job, in which printing is started after completing printing of the first print job, and the printing is completed before completing subsequent printing of the first print job.

The image forming apparatus 1 can print with higher efficiency, while printing in the order of receiving print jobs.

### Variation

The above-described image forming apparatus 1 illustrated in FIG. 1 may be implemented by an image forming system.

For example, the image forming device 10, the conveyance device 20, and the post-processing mechanism 30 can be separate devices.

As described above referring to FIG. 1, in the image forming system, the post-processing mechanism 30 includes the post-processing device 31, the buffer device 32 and the first ejection device 41. The conveyance device 20 includes the second ejection device 42. The image forming device 10 includes the sheet feed tray 11. The image forming device 10 includes the calculation unit 7, which calculates a predicted printing time required for printing for each print job based on the printing capability of the image forming device 10, and calculates a predicted post-processing time required for post-processing for each print job based on the post-processing capability of the image forming device 10. The image forming device 10 further includes the selection unit 8, which selects a second print job from a plurality of print jobs based on the predicted printing time and the predicted post-processing time.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The aspects of the present invention are as follows, for example.

According to a first aspect, an image forming apparatus includes: a buffer device to stack a plurality of sheets, each sheet having been printed and to be applied with post-processing based on a first print job, and transmit a stop signal instructing to stop the first print job when the plurality of sheets are fully stacked; a first ejection device to eject the sheet having been printed and applied with the post-processing based on the first print job; and a second ejection device to eject the sheet having been printed based on a second print job, the second print job being executed after the first print job is stopped in response to reception of the stop signal. The image forming apparatus further includes a calculation unit that calculates a predicted printing time of each print job based on printing capability, and calculates a predicted post-processing time of each print job based on post-processing capability, and a selection unit that selects a print job to be the second print job from the plurality of print jobs based on the predicted printing time and the predicted post-processing time. It is determined that the plurality of sheets are fully stacked, when the number of sheets being stacked reaches a predetermined number, such as a maximum number.

According to a second aspect, the calculation unit calculates a print suspension time during when printing of the first print job is suspended, the print suspension time being obtained by subtracting the predicted printing time from the predicted post-processing time, and calculates a cumulative print suspension time being a cumulative value of the print suspension times of the plurality of first print jobs. The selection unit selects the print job as the second print job based on a comparison between the predicted printing time and the cumulative print suspension time.

According to a third aspect, in a case where the predicted printing time of the first print job is equal to or longer than the cumulative print suspension time of the first print job received immediately before the first print job, and the predicted printing time of the first print job is less than the cumulative print suspension time of the first print job received after the first print job, excluding the print suspension time of the first print job, the selection unit selects the first print job as the second print job.

According to a fourth aspect, the image forming apparatus causes the first ejection device to eject a sheet on which job information indicating a sequence between the first print job and the second print job is printed, after printing based on the print jobs is completed.

According to a fifth aspect, an image forming system includes: a buffer device to stack a plurality of sheets, each sheet having been printed and to be applied with post-processing based on a first print job, and transmit a stop signal instructing to stop the first print job when the plurality of sheets are fully stacked; a first ejection device to eject the sheet having been printed and applied with the post-processing based on the first print job; and a second ejection device to eject the sheet having been printed based on a second print job, the second print job being executed after the first print job is stopped in response to reception of the stop signal. The image forming system further includes a calculation unit that calculates a predicted printing time of each print job based on printing capability, and calculates a predicted post-processing time of each print job based on post-processing capability, and a selection unit that selects a print job to be the second print job from the plurality of print jobs based on the predicted printing time and the predicted post-processing time.

According to a sixth aspect, an image forming method is executed by an image forming apparatus including a buffer device to stack a plurality of sheets, each sheet having been printed and to be applied with post-processing based on a first print job; a first ejection device to eject the sheet having been printed and applied with the post-processing based on the first print job; and a second ejection device to eject the sheet having been printed based on a second print job. The image forming method includes: transmitting a stop signal instructing to stop the first print job when the plurality of sheets stacked on the buffer device reaches a predetermined number; starting execution of the second print job after the first print job is stopped in response to reception of the stop signal; calculating a predicted printing time of each print job based on printing capability of the image forming apparatus; calculating a predicted post-processing time of each print job based on post-processing capability of the image forming apparatus; and selecting the second print job based on the predicted printing time and the predicted post-processing time.

According to a seventh aspect, a computer program causes an image forming apparatus to perform an image forming method. The image forming apparatus includes a buffer device to stack a plurality of sheets, each sheet having been printed and to be applied with post-processing based on a first print job; a first ejection device to eject the sheet having been printed and applied with the post-processing based on the first print job; and a second ejection device to eject the sheet having been printed based on a second print job. The image forming method includes: transmitting a stop signal instructing to stop the first print job when the plurality of sheets stacked on the buffer device reaches a predetermined number; starting execution of the second print job after the first print job is stopped in response to reception of the stop signal; calculating a predicted printing time of each print job based on printing capability of the image forming apparatus; calculating a predicted post-processing time of each print job based on post-processing capability of the image forming apparatus; and selecting the second print job based on the predicted printing time and the predicted post-processing time.

1. An image forming apparatus, comprising:
a buffer device to stack a plurality of sheets, each sheet having been printed and to be applied with post-processing based on a first print job, and transmit a stop signal instructing to stop the first print job when the plurality of sheets stacked on the buffer device reaches a predetermined number;
a first ejection device to eject the sheet having been printed and applied with the post-processing based on the first print job;
a second ejection device to eject the sheet having been printed based on a second print job, the second print job being executed after the first print job is stopped in response to reception of the stop signal; and
circuitry configured to
calculate a predicted printing time of each print job based on printing capability of the image forming apparatus,
calculate a predicted post-processing time of each print job based on post-processing capability of the image forming apparatus, and
select the second print job based on the predicted printing time and the predicted post-processing time.

2. The image forming apparatus according to claim 1, wherein, when the first job includes a plurality of first jobs, the circuitry is configured to
calculate a print suspension time during when printing of the first print job is suspended, the print suspension time being obtained by subtracting the predicted printing time from the predicted post-processing time,
calculate a cumulative print suspension time, the cumulative print suspension time being a cumulative value of the print suspension times of the plurality of first print jobs, and
select the second print job based on a comparison between the predicted printing time and the cumulative print suspension time.

3. The image forming apparatus according to claim 2, wherein the circuitry is configured to
receive each print job as the first print job,
determine the first print job to be the second print job, in a case where
the predicted printing time of the first print job is equal to or longer than the cumulative print suspension time of the first print job received immediately before the first print job, and
the predicted printing time of the first print job is less than the cumulative print suspension time of the first print job received after the first print job, excluding the print suspension time of the first print job.

4. The image forming apparatus according to claim 1, wherein
the circuitry causes the first ejection device to eject a sheet on which job information indicating a sequence between the first print job and the second print job is printed, after printing based on the first print job and the second print job is completed.

5. An image forming method, performed by an image forming apparatus,
the image forming apparatus including:
a buffer device to stack a plurality of sheets, each sheet having been printed and to be applied with post-processing based on a first print job;
a first ejection device to eject the sheet having been printed and applied with the post-processing based on the first print job; and
a second ejection device to eject the sheet having been printed based on a second print job,
the method comprising:
transmitting a stop signal instructing to stop the first print job when the plurality of sheets stacked on the buffer device reaches a predetermined number;
starting execution of the second print job after the first print job is stopped in response to reception of the stop signal;
calculating a predicted printing time of each print job based on printing capability of the image forming apparatus;
calculating a predicted post-processing time of each print job based on post-processing capability of the image forming apparatus; and
selecting the second print job based on the predicted printing time and the predicted post-processing time.

6. A non-transitory recording medium storing a plurality of instructions which, when executed by one or more processors on an image forming apparatus, perform an image forming method,
the image forming apparatus including:
a buffer device to stack a plurality of sheets, each sheet having been printed and to be applied with post-processing based on a first print job;
a first ejection device to eject the sheet having been printed and applied with the post-processing based on the first print job; and
a second ejection device to eject the sheet having been printed based on a second print job,
the method comprising:
transmitting a stop signal instructing to stop the first print job when the plurality of sheets stacked on the buffer device reaches a predetermined number;
starting execution of the second print job after the first print job is stopped in response to reception of the stop signal;
calculating a predicted printing time of each print job based on printing capability of the image forming apparatus;
calculating a predicted post-processing time of each print job based on post-processing capability of the image forming apparatus; and
selecting the second print job based on the predicted printing time and the predicted post-processing time.
